(19) United States
(12) Patent Application Publication
(10) Pub. No.: US 2014/0056041 A1
(43) Pub. Date: Feb. 27, 2014

(54) POWER GENERATION SYSTEM, POWER CONVERTER SYSTEM, AND METHODS OF OPERATING A POWER CONVERTER SYSTEM

(71) Applicants: Huibin Zhu, Westford, MA (US); David Smith, Daleville, VA (US); Maozhong Gong, Shanghai (CN); Jun Zhu, Shanghai (CN); Allen Ritter, Roanoke, VA (US); Robert Gregory Wagoner, Roanoke, VA (US); Anthony Galbraith, Wirtz, VA (US); Xueqin Wu, Shanghai (CN); Qiwei Zhang, Shanghai (CN)

(72) Inventors: Huibin Zhu, Westford, MA (US); David Smith, Daleville, VA (US); Maozhong Gong, Shanghai (CN); Jun Zhu, Shanghai (CN); Allen Ritter, Roanoke, VA (US); Robert Gregory Wagoner, Roanoke, VA (US); Anthony Galbraith, Wirtz, VA (US); Xueqin Wu, Shanghai (CN); Qiwei Zhang, Shanghai (CN)

(73) Assignee: GENERAL ELECTRIC COMPANY, Schenectady, NY (US)

(21) Appl. No.: 14/113,946

(22) PCT Filed: May 18, 2011
(86) PCT No.: PCT/CN2011/000867

§ 371 Date: Oct. 25, 2013

(51) Int. Cl. H02H 7/12; H02J 5/00

(52) U.S. Cl. CPC H02H 7/1203; H02J 5/00
USPC 363/56.01; 363/65

(57) ABSTRACT

A power converter system includes a converter configured to be coupled to a power generation unit for receiving power from the power generation unit, and a bus coupled to the converter, wherein a voltage is generated across the bus when electricity is conducted through the power converter system. The power converter system also includes an inverter coupled to the bus, wherein the inverter is configured to supply power to an electrical distribution network. A control system is coupled to at least one of the converter and the inverter, wherein the control system is configured to adjust an operation of the at least one of the converter and the inverter to reduce the voltage across the bus during at least one of a low voltage event and a high voltage event.

### BACKGROUND OF THE INVENTION

The subject matter described herein relates generally to power systems and, more particularly, to a power generation system, a power converter system, and methods of operating the power converter system.

In some known solar power systems, a plurality of photovoltaic panels (also known as solar panels) are logically or physically grouped together to form an array of solar panels. The solar panel array converts solar energy into electrical energy and transmits the energy to an electrical grid or other destination.

Solar panels generally output direct current (DC) electrical power. To properly couple such solar panels to an electrical grid, the electrical power received from the solar panels must be converted to alternating current (AC). At least some known power systems use a power converter to convert DC power to AC power. If, however, the electrical grid experiences a fault or an event in which the voltage of the electrical grid increases above a predetermined threshold or decreases below a predetermined threshold, an undesired voltage amplitude may be generated within the power converter. Such an undesired voltage amplitude may also occur during a startup and a shutdown of the power converter, as the power converter is electrically coupled to, and decoupled from, the solar panel array. Accordingly, the power converter may be damaged and/or an operational lifetime of the power converter may be reduced.

### BRIEF DESCRIPTION OF THE INVENTION

In one embodiment, a power converter system is provided that includes a converter configured to be coupled to a power generation unit for receiving power from the power generation unit, and a bus coupled to the converter, wherein a voltage is generated across the bus when electricity is conducted through the power converter system. The power converter system also includes an inverter coupled to the bus, wherein the inverter is configured to supply power to an electrical distribution network. A control system is coupled to at least one of the converter and the inverter, wherein the control system is configured to adjust an operation of the at least one of the converter and the inverter to reduce the voltage across the bus during at least one of a low voltage event and a high voltage event.

In another embodiment, a power generation system is provided that includes a power generation unit configured to generate power and a power converter system coupled to the power generation unit and to an electrical distribution network. The power converter system includes a converter configured to receive power from the power generation unit and a bus coupled to the converter, wherein a voltage is generated across the bus when electricity is conducted through the power converter system. The power converter system also includes an inverter coupled to the bus, wherein the inverter is configured to supply power to the electrical distribution network. A control system is coupled to at least one of the converter and the inverter, wherein the control system is configured to adjust an operation of the at least one of the converter and the inverter to reduce the voltage across the bus during at least one of a low voltage event and a high voltage event.

In yet another embodiment, a method of operating a power converter system is provided. The method includes enabling a switching operation of the power converter system, electrically coupling a power generation unit to the power converter system, and supplying power from the power generation unit to an electrical distribution network coupled to the power converter system.

### BRIEF DESCRIPTION OF THE DRAWINGS

FIG. 1 is a schematic diagram of an exemplary power generation system.

FIG. 2 is a flow diagram of an exemplary startup sequence of a power converter that may be used with the power generation system shown in FIG. 1.

FIG. 3 is a flow diagram of an exemplary method of operating a power converter that may be used with the power generation system shown in FIG. 1.

FIG. 4 is a flow diagram of an exemplary shutdown sequence of a power converter that may be used with the power generation system shown in FIG. 1.

FIG. 5 is a schematic diagram of a portion of an exemplary converter controller that may be used with the power generation system shown in FIG. 1.

FIG. 6 is a graphical view of an exemplary power output curve of the boost converter shown in FIG. 1.

FIG. 7 is a schematic diagram of a portion of an exemplary inverter controller that may be used with the power generation system shown in FIG. 1.

FIG. 8 is a schematic diagram of a portion of another exemplary inverter controller that may be used with the power generation system shown in FIG. 1.

FIG. 9 is a schematic diagram of a portion of another exemplary inverter controller that may be used with the power generation system shown in FIG. 1.

FIG. 10 is a schematic diagram of a portion of yet another exemplary inverter controller that may be used with the power generation system shown in FIG. 1.

FIG. 11 is a schematic diagram of an alternative power generation system.

### DETAILED DESCRIPTION OF THE INVENTION

As described herein, a power generation system includes a power converter and at least one power generation unit, such as a solar array. The power converter includes a boost converter coupled to the solar array, and an inverter coupled to the boost converter by a DC bus. The inverter is coupled to an electrical distribution network for supplying electrical energy to the network. A converter controller controls the operation of the boost converter, and an inverter controller controls the operation of the inverter. The converter controller and the inverter controller adjust the operation of the boost converter and the inverter, respectively, to adjust the voltage across the DC bus if the electrical distribution network has a different voltage than the voltage supplied by the solar array and/or if an error or fault condition occurs within the electrical distribution network. Accordingly, the power converter and the methods described herein enable the power generation system to operate during low voltage events and/or high voltage events without sustaining undesired voltage amplitudes across the DC bus.

As used herein, the term “low voltage event” refers to an event in which the voltage of at least one phase of the electrical distribution network is lower than a nominal voltage of one or more phases of the electrical distribution network such that the power converter is unable to convert the full amount of power supplied by the solar array. Accordingly, low voltage events may occur during a low voltage ride-through (LVRT) event, a zero voltage ride-through (ZVRT) event, during a fault or error condition within the electrical distribution network, during a startup of the power converter, during a shutdown of the power converter, and/or during any other suitable event. As used herein, the term “high voltage event” refers to an event in which the voltage of at least one phase of the electrical distribution network is higher than the nominal voltage of one or more phases of the electrical distribution network. Accordingly, high voltage events may occur during a high voltage ride-through (HVRT) event, during a fault or error condition within the electrical distribution network, and/or during any other suitable event. Low voltage events and/or high voltage events may cause the DC bus to experience an overvoltage condition. As used herein, the term “overvoltage condition” refers to an event when the voltage across the DC bus exceeds a predetermined operational threshold such that the voltage across DC bus rises to an undesired voltage.

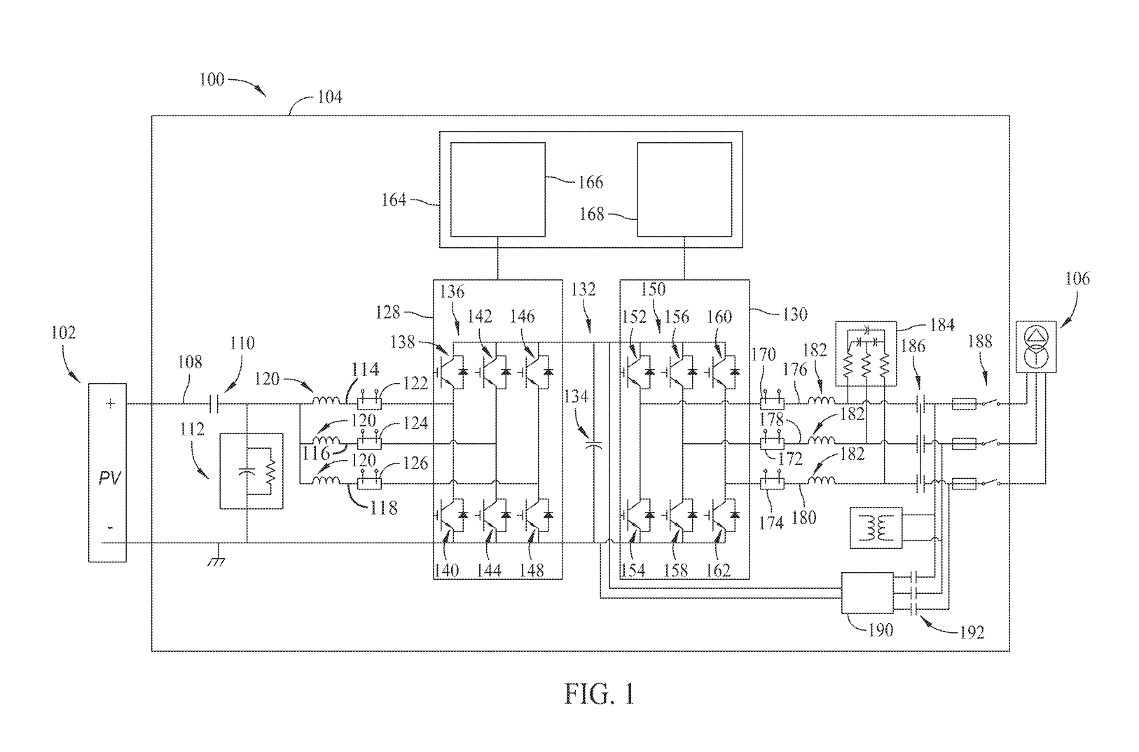

FIG. 1 is a schematic diagram of an exemplary power generation system 100 that includes a plurality of power generation units, such as a plurality of solar panels (not shown) that form at least one solar array 102. Alternatively, power generation system 100 includes any suitable number and type of power generation units, such as a plurality of wind turbines, fuel cells, geothermal generators, hydropower generators, and/or other devices that generate power from renewable and/or non-renewable energy sources.

In the exemplary embodiment, power generation system 100 and/or solar array 102 includes any number of solar panels to facilitate operating power generation system 100 at a desired power output. In one embodiment, power generation system 100 includes a plurality of solar panels and/or solar arrays 102 coupled together in a series-parallel configuration to facilitate generating a desired current and/or voltage output from power generation system 100. Solar panels include, in one embodiment, one or more of a photovoltaic panel, a solar thermal collector, or any other device that converts solar energy to electrical energy. In the exemplary embodiment, each solar panel is a photovoltaic panel that generates a substantially direct current (DC) power as a result of solar energy striking solar panels.

In the exemplary embodiment, solar array 102 is coupled to a power converter 104, or a power converter system 104, that converts the DC power to alternating current (AC) power. The AC power is transmitted to an electrical distribution network 106, or “grid.” Power converter 104, in the exemplary embodiment, adjusts an amplitude of the voltage and/or current of the converted AC power to an amplitude suitable for electrical distribution network 106, and provides AC power at a frequency and a phase that are substantially equal to the frequency and phase of electrical distribution network 106. Moreover, in the exemplary embodiment, power converter 104 provides three phase AC power to electrical distribution network 106. Alternatively, power converter 104 provides single phase AC power or any other number of phases of AC power to electrical distribution network 106.

DC power generated by solar array 102, in the exemplary embodiment, is transmitted through a converter conductor 108 coupled to power converter 104. In the exemplary embodiment, a protection device 110 electrically disconnects solar array 102 from power converter 104, for example, if an error or a fault occurs within power generation system 100. As used herein, the terms “disconnect” and “decouple” are used interchangeably, and the terms “connect” and “couple” are used interchangeably. Current protection device 110 is a circuit breaker, a fuse, a contactor, and/or any other device that enables solar array 102 to be controllably disconnected from power converter 104. A DC filter 112 is coupled to converter conductor 108 for use in filtering an input voltage and/or current received from solar array 102.

Converter conductor 108, in the exemplary embodiment, is coupled to a first input conductor 114, a second input conductor 116, and a third input conductor 118 such that the input current is split between first, second, and third input conductors 114, 116, and 118. Alternatively, the input current may be conducted to a single conductor, such as converter conductor 108, and/or to any other number of conductors that enables power generation system 100 to function as described herein. At least one inductor 120 is coupled to each of first input conductor 114, second input conductor 116, and/or third input conductor 118. Inductors 120 facilitate filtering the input voltage and/or current received from solar array 102.

In the exemplary embodiment, a first input current sensor 122 is coupled to first input conductor 114, a second input current sensor 124 is coupled to second input conductor 116, and a third input current sensor 126 is coupled to third input conductor 118. First, second, and third input current sensors 122, 124, and 126 measure the current flowing through first, second, and third input conductors 114, 116, and 118, respectively.

In the exemplary embodiment, power converter 104 includes a DC to DC, or “boost,” converter 128 and an inverter 130 coupled together by a DC bus 132. Boost converter 128, in the exemplary embodiment, is coupled to, and receives DC power from, solar array 102 through first, second, and third input conductors 114, 116, and 118. Moreover, boost converter 128 adjusts the voltage and/or current amplitude of the DC power received. In the exemplary embodiment, inverter 130 is a DC-AC inverter that converts DC power received from boost converter 128 into AC power for transmission to electrical distribution network 106. Moreover, in the exemplary embodiment, DC bus 132 includes at least one capacitor 134. Alternatively, DC bus 132 includes a plurality of capacitors 134 and/or any other electrical power storage devices that enable power converter 104 to function as described herein. As current is transmitted through power converter 104, a voltage is generated across DC bus 132 and energy is stored within capacitors 134.

Boost converter 128, in the exemplary embodiment, includes two converter switches 136 coupled together in serial arrangement for each phase of electrical power that power converter 104 produces. In the exemplary embodiment, converter switches 136 are insulated gate bipolar transistors (IGBTs). Alternatively, converter switches 136 are any other suitable transistor or any other suitable switching device. Moreover, each pair of converter switches 136 for each phase is coupled in parallel with each pair of converter switches 136 for each other phase. As such, for a three phase power converter 104, boost converter 128 includes a first converter switch 138 coupled in series with a second converter switch 140, a third converter switch 142 coupled in series with a fourth converter switch 144, and a fifth converter switch 146 coupled in series with a sixth converter switch 148. First and second converter switches 138 and 140 are coupled in parallel with third and fourth converter switches 142 and 144, and with fifth and sixth converter switches 146 and 148. Alternatively, boost converter 128 may include any suitable number of converter switches 136 arranged in any suitable configuration.

Inverter 130, in the exemplary embodiment, includes two inverter switches 150 coupled together in serial arrangement for each phase of electrical power that power converter 104 produces. In the exemplary embodiment, inverter switches 150 are insulated gate bipolar transistors (IGBTs). Alternatively, inverter switches 150 are any other suitable transistor or any other suitable switching device. Moreover, each pair of inverter switches 150 for each phase is coupled in parallel with each pair of inverter switches 150 for each other phase. As such, for a three phase power converter 104, inverter 130 includes a first inverter switch 152 coupled in series with a second inverter switch 154, a third inverter switch 156 coupled in series with a fourth inverter switch 158, and a fifth inverter switch 160 coupled in series with a sixth inverter switch 162. First and second inverter switches 152 and 154 are coupled in parallel with third and fourth inverter switches 156 and 158, and with fifth and sixth inverter switches 160 and 162. Alternatively, inverter 130 may include any suitable number of inverter switches 150 arranged in any suitable configuration.

Power converter 104 includes a control system 164 that includes a converter controller 166 and an inverter controller 168. Converter controller 166 is coupled to, and controls an operation of, boost converter 128. More specifically, in the exemplary embodiment, converter controller 166 operates boost converter 128 to maximize the power received from solar array 102. Inverter controller 168 is coupled to, and controls the operation of, inverter 130. More specifically, in the exemplary embodiment, inverter controller 168 operates inverter 130 to regulate the voltage across DC bus 132 and/or to adjust the voltage, current, phase, frequency, and/or any other characteristic of the power output from inverter 130 to substantially match the characteristics of electrical distribution network 106.

In the exemplary embodiment control system 164, converter controller 166, and/or inverter controller 168 include and/or are implemented by at least one processor. As used herein, the processor includes any suitable programmable circuit such as, without limitation, one or more systems and microcontrollers, microprocessors, reduced instruction set circuits (RISC), application specific integrated circuits (ASIC), programmable logic circuits (PLC), field programmable gate arrays (FPGA), and/or any other circuit capable of executing the functions described herein. The above examples are exemplary only, and thus are not intended to limit in any way the definition and/or meaning of the term “processor.”

Converter controller 166, in the exemplary embodiment, receives current measurements from first input current sensor 122, second input current sensor 124, and/or third input current sensor 126. Moreover, converter controller 166 receives measurements of a voltage of first input conductor 114, second input conductor 116, and/or third input conductor 118 from a plurality of input voltage sensors (not shown). Inverter controller 168, in the exemplary embodiment, receives current measurements from a first output current sensor 170, a second output current sensor 172, and/or a third output current sensor 174. Moreover, inverter controller 168 receives measurements of a voltage output from inverter 130 from a plurality of output voltage sensors (not shown). In the exemplary embodiment, converter controller 166 and/or inverter controller 168 receive voltage measurements of the voltage of DC bus 132 from a DC bus voltage sensor (not shown).

In the exemplary embodiment, inverter 130 is coupled to electrical distribution network 106 by a first output conductor 176, a second output conductor 178, and a third output conductor 180. Moreover, in the exemplary embodiment, inverter 130 provides a first phase of AC power to electrical distribution network 106 through first output conductor 176, a second phase of AC power to electrical distribution network 106 through second output conductor 178, and a third phase of AC power to electrical distribution network 106 through third output conductor 180. First output current sensor 170 is coupled to first output conductor 176 for measuring the current flowing through first output conductor 176. Second output current sensor 172 is coupled to second output conductor 178 for measuring the current flowing through second output conductor 178, and third output current sensor 174 is coupled to third output conductor 180 for measuring the current flowing through third output conductor 180.

At least one inductor 182 is coupled to each of first output conductor 176, second output conductor 178, and/or third output conductor 180. Inductors 182 facilitate filtering the output voltage and/or current received from inverter 130. Moreover, in the exemplary embodiment, an AC filter 184 is coupled to first output conductor 176, second output conductor 178, and/or third output conductor 180 for use in filtering an output voltage and/or current received from conductors 176, 178, and 180.

In the exemplary embodiment, at least one contactor 186 and/or at least one disconnect switch 188 are coupled to first output conductor 176, second output conductor 178, and/or third output conductor 180. Contactors 186 and disconnect switches 188 electrically disconnect inverter 130 from electrical distribution network 106, for example, if an error or a fault occurs within power generation system 100. Moreover, in the exemplary embodiment, protection device 110, contactors 186 and disconnect switches 188 are controlled by control system 164. Alternatively, protection device 110, contactors 186 and/or disconnect switches 188 are controlled by any other system that enables power converter 104 to function as described herein.

Power converter 104 also includes a bus charger 190 that is coupled to first output conductor 176, second output conductor 178, third output conductor 180, and to DC bus 132. In the exemplary embodiment, at least one charger contactor 192 is coupled to bus charger 190 for use in electrically disconnecting bus charger 190 from first output conductor 176, second output conductor 178, and/or third output conductor 180. Moreover, in the exemplary embodiment, bus charger 190 and/or charger contactors 192 are controlled by control system 164 for use in charging DC bus 132 to a predetermined voltage.

During operation, in the exemplary embodiment, solar array 102 generates DC power and transmits the DC power to boost converter 128. Converter controller 166 controls a switching of converter switches 136 to adjust an output of boost converter 128. More specifically, in the exemplary embodiment, converter controller 166 controls the switching of converter switches 136 to adjust the voltage and/or current received from solar array 102 such that the power received from solar array 102 is increased and/or maximized.

Inverter controller 168, in the exemplary embodiment, controls a switching of inverter switches 150 to adjust an output of inverter 130. More specifically, in the exemplary embodiment, inverter controller 168 uses a suitable control algorithm, such as pulse width modulation (PWM) and/or any other control algorithm, to transform the DC power received from boost converter 128 into three phase AC power signals. Alternatively, inverter controller 168 causes inverter 130 to transform the DC power into a single phase AC power signal or any other signal that enables power converter 104 to function as described herein.

In the exemplary embodiment, each phase of the AC power is filtered by AC filter 184, and the filtered three phase AC power is transmitted to electrical distribution network 106. In the exemplary embodiment, three phase AC power is also transmitted from electrical distribution network 106 to DC bus 132 by bus charger 190. Bus charger 190 uses the AC power to charge DC bus 132 to a suitable voltage amplitude, for example, during a startup and/or a shutdown sequence of power converter 104.

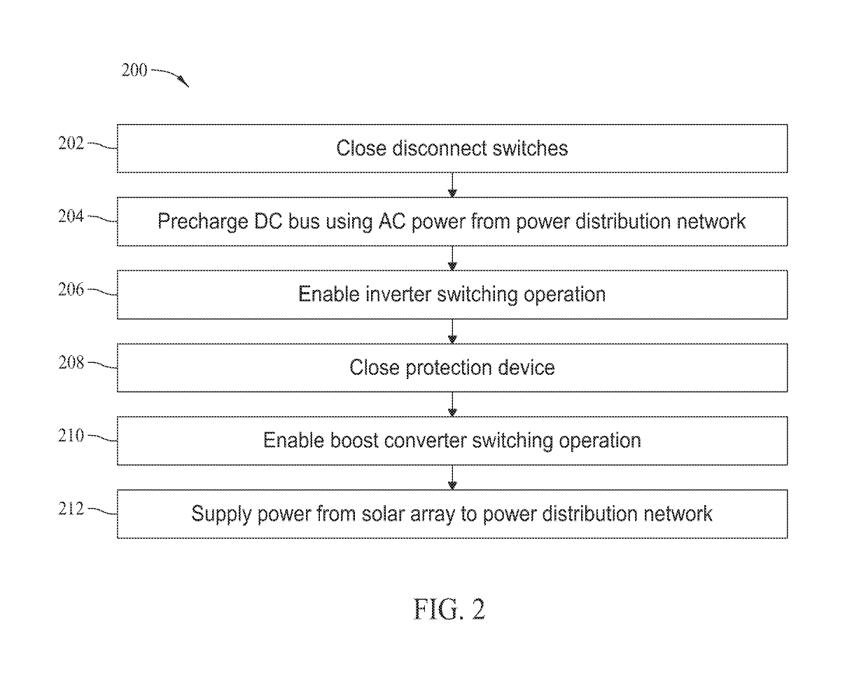

FIG. 2 is a flow diagram of an exemplary startup sequence 200 of power converter 104 (shown in FIG. 1). In the exemplary embodiment, startup sequence 200 is implemented by control system 164, such as by converter controller 166 and/or inverter controller 168. Alternatively, startup sequence 200 may be implemented by any other system that enables power converter 104 to function as described herein.

In the exemplary embodiment, before startup sequence 200 begins, boost converter 128 and inverter 130 are in a stopped state (i.e., boost converter 128 and inverter 130 are not switched, but converter switches 136 and inverter switches 150 are maintained at an open state). Moreover, protection device 110, contactors 186, and/or disconnect switches 188 are open such that solar array 102 is disconnected from power converter 104 and power converter 104 is disconnected from electrical distribution network 106. Startup sequence 200 begins by closing 202 disconnect switches 188 and/or contactors 186 such that AC power from electrical distribution network 106 is enabled to be transmitted to power converter 104. DC bus 132 is precharged 204 using AC power from electrical distribution network 106 and using bus charger 190 (shown in FIG. 1). A switching operation of inverter 130 is enabled 206 while solar array 102 remains disconnected from power converter 104 by protection device 110. As used herein, the terms “switching” and “switching operation” refer to controlling switches, such as converter switches 136 and/or inverter switches 150, to open and close based on signals received from a control system, such as control system 164. Accordingly, an excessive inrush current from solar array 102 and a high voltage at DC bus 132 may be prevented during startup of power converter 104.

Protection device 110 is closed 208 to electrically couple solar array 102 to power converter 104. A switching operation of boost converter 128 is enabled 210, and electrical power from solar array 102 is supplied 212 to electrical distribution network 106 as described more fully above with respect to FIG. 1.

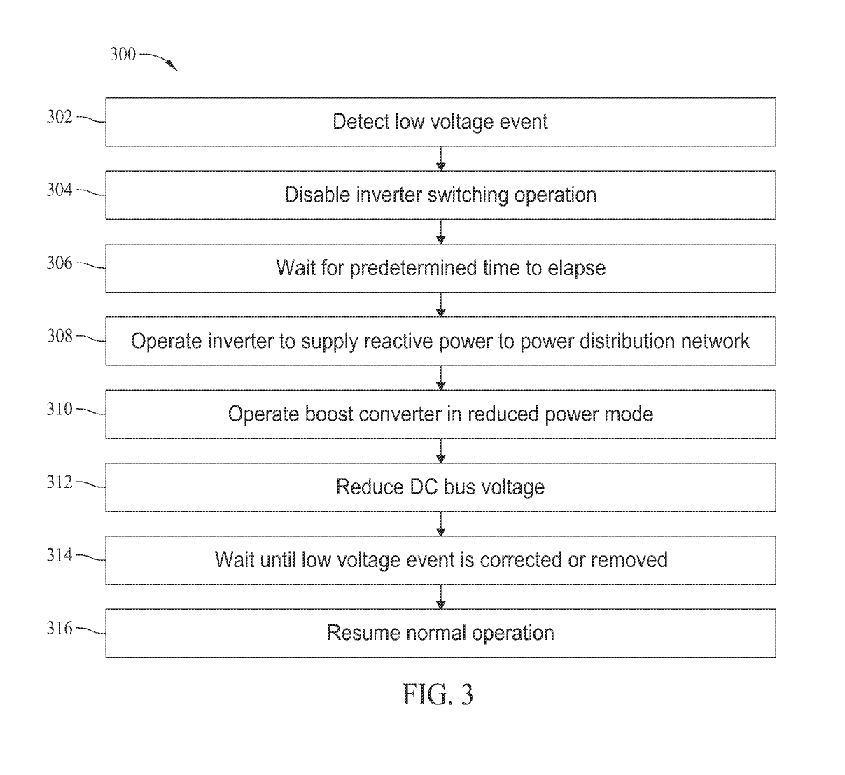

FIG. 3 is a flow diagram of an exemplary method 300 of operating power converter 104 (shown in FIG. 1) during a low voltage event. In the exemplary embodiment, method 300 is implemented by control system 164, such as by converter controller 166 and/or inverter controller 168. Alternatively, method 300 may be implemented by any other system that enables power converter 104 to function as described herein.

In the exemplary embodiment, a low voltage event is detected 302, for example, within electrical distribution network 106 (shown in FIG. 1). After a low voltage event has been detected 302, the switching operation of inverter 130 is disabled 304 and inverter switches 150 are maintained in an open state such that current is prevented from flowing through inverter 130. More specifically, disabling 304 the switching operation of inverter 130 reduces or prevents a reverse current from flowing through inverter 130 from electrical distribution network 106. After the switching operation of inverter 130 is disabled 304, method 300 waits 306 for a predetermined time to elapse. In the exemplary embodiment, the predetermined time is between about 5 milliseconds (ms) to about 10 ms. In a specific embodiment, the predetermined time is about 10 ms. Alternatively, the predetermined time may be any suitable time that enables method 300 to function as described herein.

In the exemplary embodiment, after the predetermined time has elapsed, inverter 130 is operated 308 to supply reactive power to electrical distribution network 106. More specifically, inverter controller 168 enables a switching operation of inverter switches 150 and adjusts the phase of the power supplied from inverter 130 to supply a desired amount of reactive power to electrical distribution network 106. Boost converter 128 is operated 310 in a reduced power mode to reduce 312 the voltage across DC bus 132 during the low voltage event. In the exemplary embodiment, the reduced power mode is enabled by controlling the switching of converter switches 136 at a high duty cycle, such as about a 95% duty cycle. Such an operation causes the voltage across DC bus 132 to be reduced 312, and the power transmitted through boost converter 128 is decreased. Alternatively, converter switches 136 may be switched at any suitable duty cycle that enables method 300 to function as described herein.

While operating 310 boost converter 128 in the reduced power mode, control system 164 waits 314 until the low voltage event has been corrected or removed. Once the low voltage event has been corrected or removed, power converter 104 resumes 316 normal operation. More specifically, boost converter 128 is switched in a mode that maximizes power output from solar array 102 such that a maximum amount of power is transmitted to DC bus 132. Inverter 130 is switched in a mode that transforms the DC power from DC bus 132 into substantially sinusoidal three phase AC power signals, as described above.

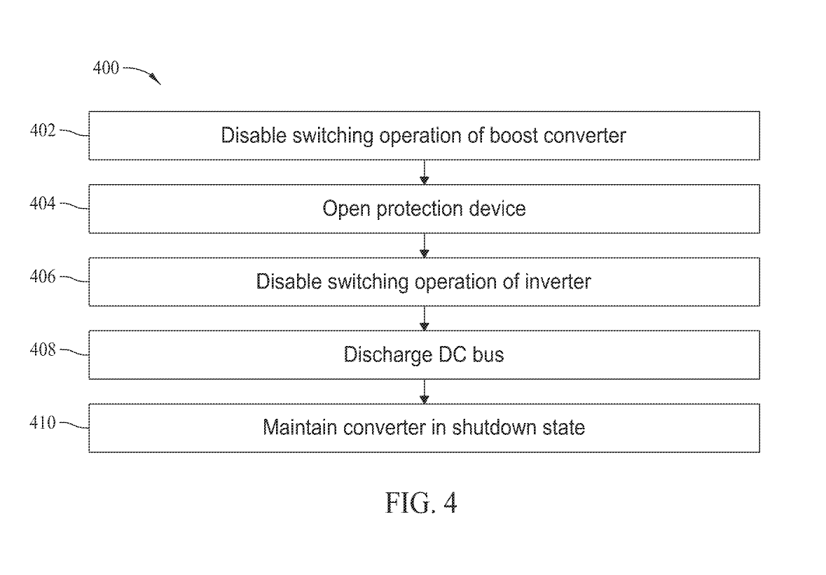

FIG. 4 is a flow diagram of an exemplary shutdown sequence 400 of power converter 104 (shown in FIG. 1). In the exemplary embodiment, shutdown sequence 400 is implemented by control system 164, such as by converter controller 166 and/or inverter controller 168. Alternatively, shutdown sequence 400 may be implemented by any other system that enables power converter 104 to function as described herein.

In the exemplary embodiment, shutdown sequence 400 disables 402 the switching operation of boost converter 128 (shown in FIG. 1). Protection device 110 is opened 404, thus electrically disconnecting solar array 102 from boost converter 128. Accordingly, current ceases flowing from solar array 102 through boost converter 128 to inverter 130. The switching operation of inverter 130 is disabled 406 such that current ceases flowing through inverter to electrical distribution network 106. As such, by disconnecting solar array 102 from boost converter 128 before disabling 406 the switching operation of inverter 130, a reverse current from power distribution network is reduced or prevented from flowing back into power converter 104 from electrical distribution network 106.

DC bus 132 is discharged 408, for example, through a resistive component (not shown) coupled across DC bus 132, such that a voltage across DC bus 132 and/or the energy stored in capacitors 134 (shown in FIG. 1) is reduced. After DC bus 132 is discharged 408, power converter 104 is in a shutdown state. Power converter 104 is maintained 410 in the shutdown state until startup sequence 200 (shown in FIG. 2) is executed and/or another suitable sequence is executed.

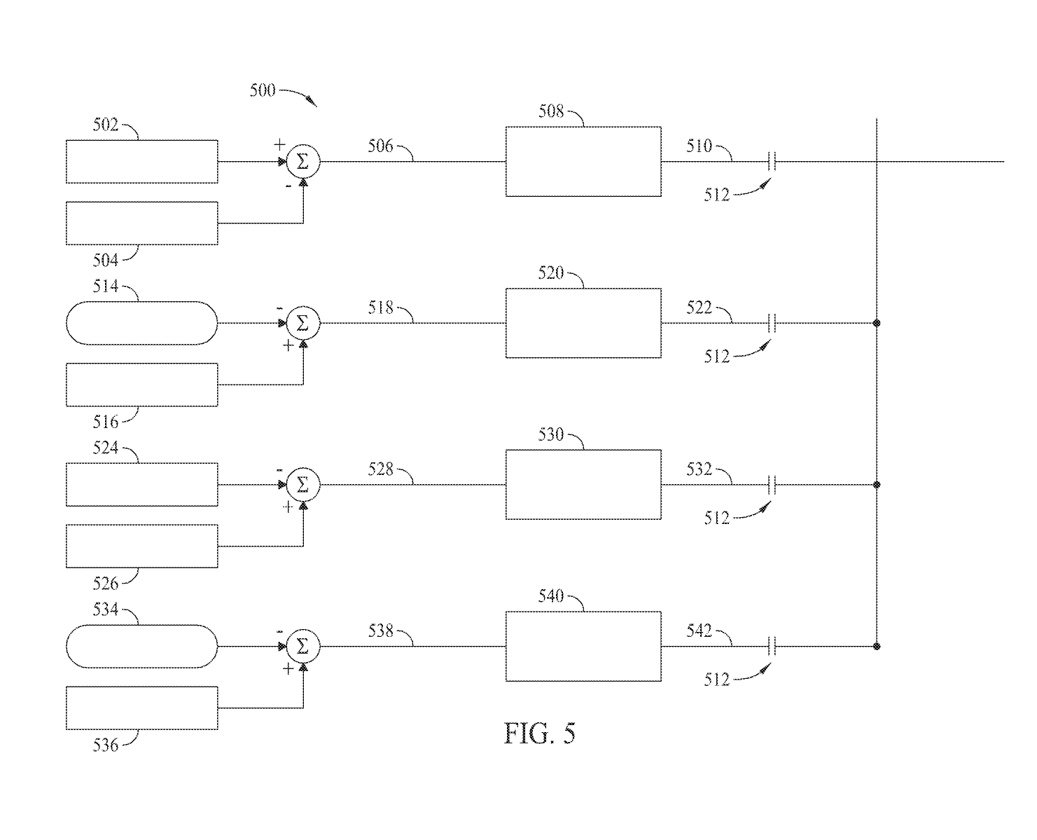

FIG. 5 is a schematic diagram of a portion of an exemplary converter controller 500 that may be used with power generation system 100 (shown in FIG. 1). In the exemplary embodiment, converter controller 500 compares an array voltage reference signal 502 with a measured array voltage signal 504 received from one or more voltage sensors (not shown) positioned proximate an output of solar array 102 and/or at any suitable location. The comparison of array voltage reference signal 502 and measured array voltage signal 504 generates an array voltage error signal 506. An array DC voltage regulator 508 receives array voltage error signal 506 and generates an array voltage control signal 510 to offset or correct for array voltage error signal 506. Array voltage control signal 510 is transmitted to switching circuitry (not shown) for use in controlling the switching of converter switches 136. At least one contactor 512 is operated to selectively enable or disable the output of array voltage control signal 510 to the switching circuitry.

In the exemplary embodiment, converter controller 500 compares an array current limit 514 with a measured array current signal 516 received from first, second, and/or third input current sensor 122, 124, and/or 126 (shown in FIG. 1). The comparison of array current limit 514 and measured array current signal 516 generates an over current error signal 518. An over current regulator 520 receives over current error signal 518 and generates an over current control signal 522 to offset or correct for over current error signal 518. Over current control signal 522 is transmitted to the switching circuitry for use in controlling the switching of converter switches 136. Moreover, at least one contactor 512 is operated to selectively enable or disable the output of over current control signal 522 to the switching circuitry.

Converter controller 500, in the exemplary embodiment, compares an array power limit 524 with a measured array power signal 526 received and/or calculated from one or more input voltage sensors, from first, second, and/or third input current sensor 122, 124, and/or 126, and/or from any other sensor or combination of sensors that measures and/or calculates the power provided by solar array 102. The comparison of array power limit 524 and measured array power signal 526 generates an over power error signal 528. An over power regulator 530 receives over power error signal 528 and generates an over power control signal 532 to offset or correct for over power error signal 528. Over power control signal 532 is transmitted to the switching circuitry for use in controlling the switching of converter switches 136. At least one contactor 512 is operated to selectively enable or disable the output of over current control signal 532 to the switching circuitry.

Moreover, a DC bus voltage change limit 534 is compared with a measured voltage change signal 536 calculated from a change in a voltage signal received from a DC bus voltage sensor (not shown). DC bus voltage change limit 534 represents a maximum voltage change allowed in the voltage across DC bus 132. Measured voltage change signal 536 represents a measured change in the voltage across DC bus 132. The comparison of DC bus voltage change limit 534 and measured voltage change signal 536 generates a voltage change error signal 538. A voltage change regulator 540 receives voltage change error signal 538 and generates a voltage change control signal 542 to offset or correct for voltage change error signal 538. Voltage change control signal 542 is transmitted to the switching circuitry for use in controlling the switching of converter switches 136. Moreover, at least one contactor 512 is operated to selectively enable or disable the output of voltage change control signal 542 to the switching circuitry.

In an alternative embodiment, voltage change control signal 542 is compared with array voltage error signal 506, and a signal representative of the resulting comparison is transmitted to array DC voltage regulator 508. In such an embodiment, array DC voltage regulator 508 generates array voltage control signal 510 to offset or correct for the combined array voltage error signal 506 and voltage change control signal 542. Array voltage control signal 510 is transmitted to switching circuitry (not shown) for use in controlling the switching of converter switches 136, as described above. Moreover, in such an embodiment, array voltage control signal 510 facilitates maintaining the voltage across DC bus 132 within a predetermined limit and facilitates minimizing or reducing changes in the voltage across DC bus 132.

As described herein, in the exemplary embodiment, array DC voltage regulator 508, over current regulator 520, and over power regulator 530 provide feedback control loops that facilitate maintaining the input current, the input voltage, and/or the input power of boost converter 128 within predetermined limits. Moreover, voltage change regulator 540 facilitates reducing and/or controlling the voltage change across DC bus 132. Accordingly, during an error or a fault within power generation system 100 and/or during a low voltage event and/or a high voltage event, voltage change regulator 540 facilitates protecting DC bus 132, power converter 104, and/or solar array 102 from damage due to rapid voltage changes that might otherwise occur.

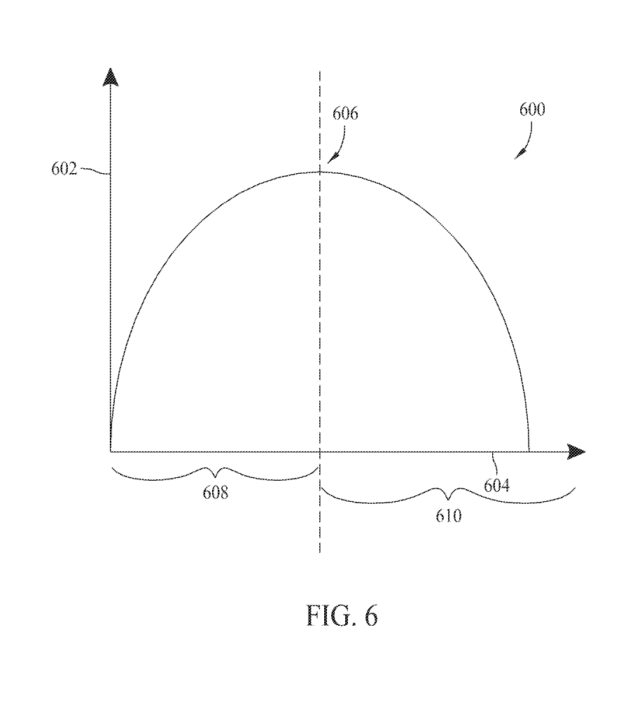

FIG. 6 is a graphical view of an exemplary power output curve 600 of boost converter 128 (shown in FIG. 1). The ordinate axis represents a power output 602 of boost converter 128, and the abscissa axis represents a voltage output 604 of boost converter 128. During normal operation, boost converter 128 is operated at a voltage output 604 and at a current output (not shown) that yield a maximum power level 606. A first operating region 608 defines a low voltage and high current mode of operation with respect to the voltage and current levels at maximum power level 606. A second operating region 610 defines a high voltage and low current mode of operation with respect to the voltage and current levels at maximum power level 606.

During a low voltage event, during startup of power converter 104, and/or during any other time period in which solar array 102 is capable of supplying more power than electrical distribution network 106 (both shown in FIG. 1) and/or power converter 104 can accept, boost converter 128 is operated within first operating region 608. In one embodiment, first operating region 608 represents the reduced power mode described above with reference to FIG. 3. In the exemplary embodiment, converter controller 166 controls the switching of converter switches 136 (both shown in FIG. 1) at a substantially high duty cycle, such as at about a 95% duty cycle. Alternatively, converter controller 166 controls the switching of converter switches 136 at any other duty cycle to enable boost converter 128 to be operated within first operating region 608 and/or any other operating region. Accordingly, in the exemplary embodiment, during a low voltage event and/or during startup, power converter 104 (shown in FIG. 1) provides a substantially low voltage to electrical distribution network 106 to avoid a high voltage across DC bus 132 and/or to avoid a high rate of change of the voltage across DC bus 132.

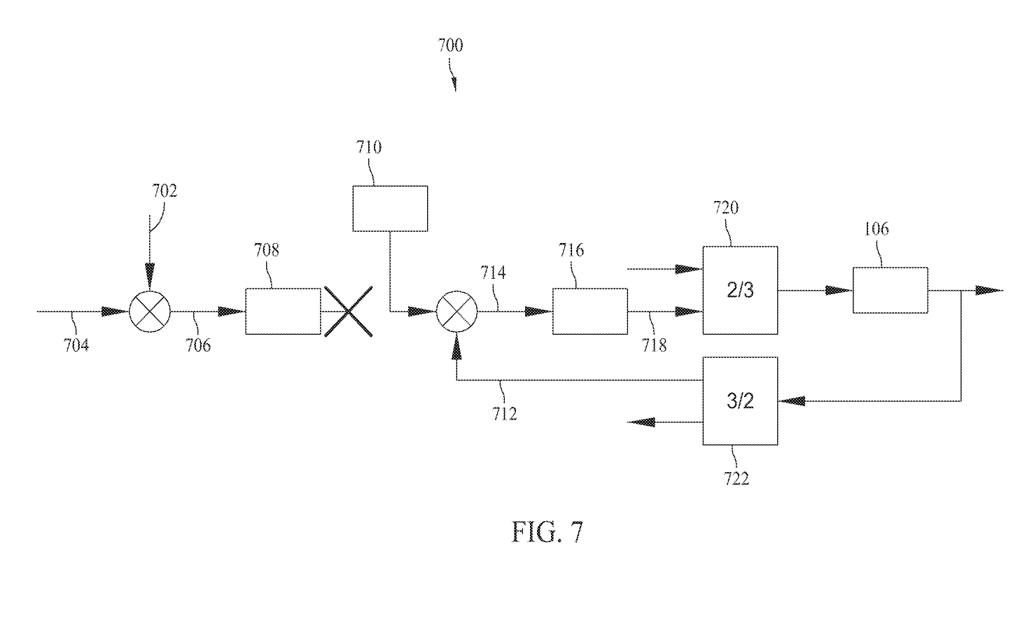

FIG. 7 is a schematic diagram of a portion of an exemplary inverter controller 700 that may be used with power generation system 100 (shown in FIG. 1). In the exemplary embodiment, inverter 130 provides at least one current (hereinafter referred to as the “inverter current”) and at least one voltage (hereinafter referred to as the “inverter voltage”) that each includes a real component (also known as an “x” component) and a reactive component (also known as a “y” component).

In the exemplary embodiment, a DC bus voltage sensor (not shown) measures the voltage across DC bus 132 (shown in FIG. 1) and transmits a DC bus voltage feedback signal 702 to inverter controller 700. Inverter controller 700 identifies a desired voltage amplitude of DC bus 132 and generates a DC bus voltage command signal 704 representative of the desired voltage amplitude. Inverter controller 700 compares DC bus voltage feedback signal 702 to DC bus voltage command signal 704 and generates a DC bus voltage error signal 706 to a DC bus voltage regulator 708 for use in determining a desired or maximum current to be transmitted through inverter 130. However, during a startup of power converter 104, and as illustrated in FIG. 7, an output of DC bus voltage regulator 708 is disabled and the voltage across DC bus 132 is maintained at a reduced amplitude as compared to normal operation. Such a configuration of inverter controller 700 facilitates reducing or minimizing damage due to an inrush current that may be transmitted through power converter 104 when solar array 102 is electrically coupled to power converter 104.

During startup or any other suitable operation of power converter 104, a real current limit reference signal 710 is used in place of the output of DC bus voltage regulator 708 to identify an upper limit for the real component of the inverter current. Inverter controller 700 compares real current limit reference signal 710 to a real current feedback signal 712 received from first, second, and/or third output current sensor 170, 172, and/or 174 (shown in FIG. 1). A resulting real current error signal 714 is transmitted to a real current regulator 716. In the exemplary embodiment, real current regulator 716 generates a real voltage command signal 718 that is transformed into a stationary reference frame by an output reference frame converter 720. A signal generated by output reference frame converter 720 is used to control the switching of inverter switches 150 (shown in FIG. 1), and the inverter current is transmitted to electrical distribution network 106. A portion of the inverter current is transmitted back as real current feedback signal 712 after undergoing a transformation into a rotating reference frame by an input reference frame converter 722.

After the startup of power converter 104 has been completed, the output from DC bus voltage regulator 708 is enabled and the output signal replaces real current limit reference signal 710. During a shutdown or another suitable operating mode of power converter 104, the output of DC bus voltage regulator 708 is disabled and inverter controller 700 uses real current limit reference signal 710 to identify the upper limit of the real component of the inverter current.

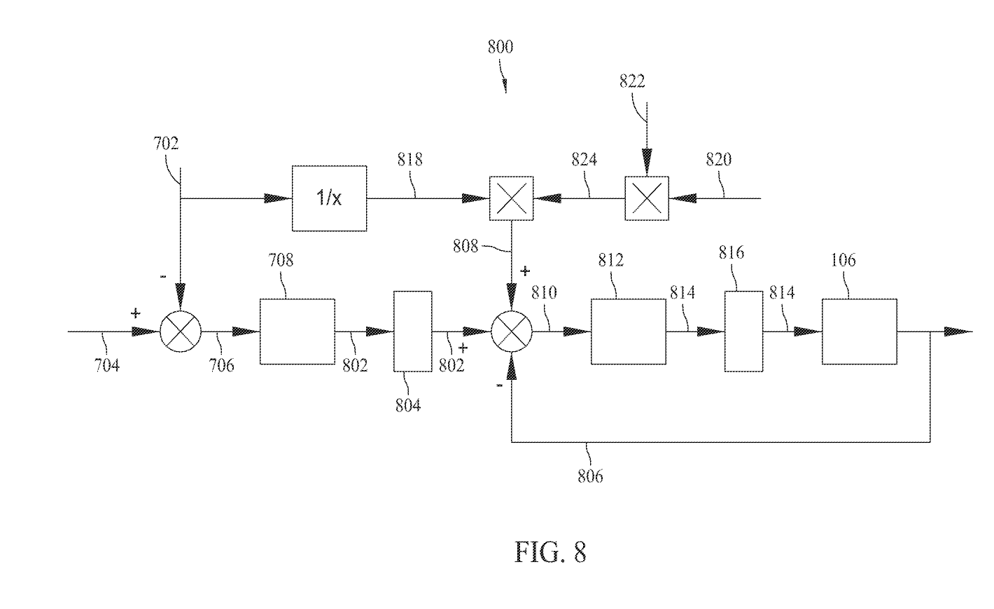

FIG. 8 is a schematic view of a portion of another exemplary inverter controller 800 that may be used with power generation system 100 (shown in FIG. 1). Unless otherwise specified, inverter controller 800 is substantially similar to inverter controller 700 (shown in FIG. 7), and components of FIG. 8 that are similar to components of FIG. 7 are illustrated with the same reference numerals in FIG. 8 as are used in FIG. 7.

In the exemplary embodiment, DC bus voltage feedback signal 702 is compared with DC bus voltage command signal 704, and the resulting DC bus voltage error signal 706 is transmitted to DC bus voltage regulator 708. A current command signal 802 is generated by DC bus voltage regulator 708 and signal 802 is adjusted by a first limiter 804 to ensure that an amplitude of signal 802 is within predetermined upper and lower limits. Current command signal 802 is compared to an inverter current feedback signal 806 and to an inverter current command signal 808. Inverter current feedback signal 806 is received from first, second, and/or third output current sensor 170, 172, and/or 174 (shown in FIG. 1), and inverter current command signal 808 is described more fully herein.

A current error signal 810 is generated as a result of the comparison, and current error signal 810 is transmitted to a current regulator 812. In the exemplary embodiment, current regulator 812 generates a voltage command signal 814, and signal 814 is adjusted by a second limiter 816 to ensure that an amplitude of signal 814 is within predetermined upper and lower limits. Voltage command signal 814 is used to control the switching of inverter switches 150 (shown in FIG. 1). Current is transmitted through inverter switches 150 to electrical distribution network 106, and a portion of the current is transmitted back to inverter 800 as inverter current feedback signal 806.

In the exemplary embodiment, a portion of DC bus voltage feedback signal 702 is inverted to generate an inverted DC bus voltage signal 818. Alternatively, a portion of DC bus voltage command signal 704 is inverted to generate inverted DC bus voltage signal 818. Moreover, in the exemplary embodiment, an array voltage signal 820 is multiplied by an array current signal 822. In the exemplary embodiment, array current signal 822 is received from first, second, and/or third input current sensor 122, 124, and/or 126, and array voltage signal 820 is received from one or more input voltage sensors (not shown) positioned proximate first, second, and/or third input current sensor 122, 124, and/or 126 and/or positioned at any suitable location.

An array power signal 824 is generated as a result of the multiplication of array voltage signal 820 and array current signal 822. Array power signal 824 is multiplied by inverted DC bus voltage signal 818 such that array power signal 824 is effectively divided by DC bus voltage feedback signal 702. Inverter current command signal 808 is generated by the multiplication of array power signal 824 and inverted DC bus voltage signal 818. Inverter current command signal 808 is compared to current command signal 802 and inverter current feedback signal 806 as described above.

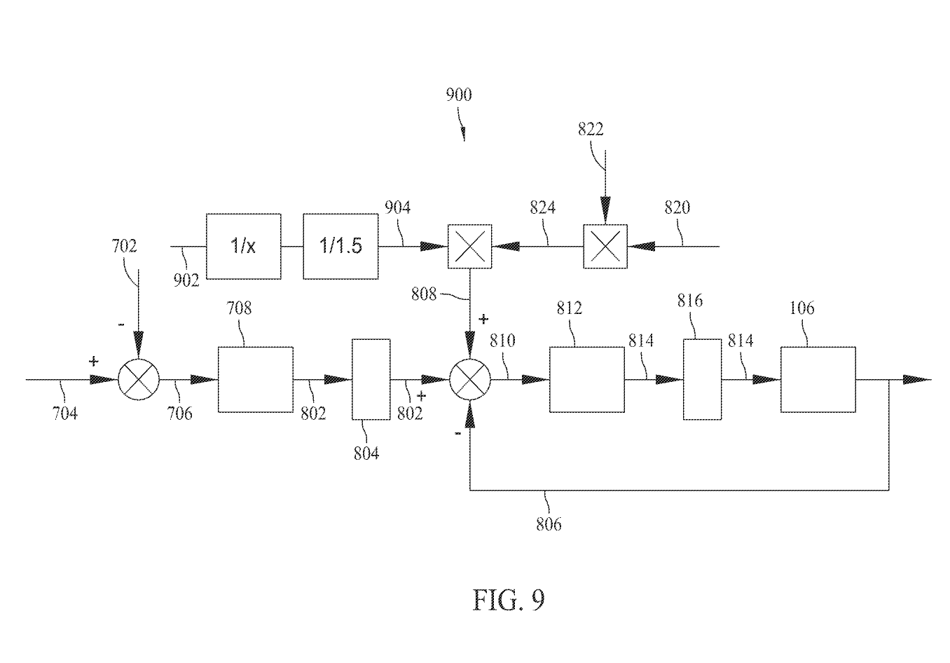

FIG. 9 is a schematic diagram of a portion of another exemplary inverter controller 900 that may be used with power generation system 100 (shown in FIG. 1). Unless otherwise specified, inverter controller 900 is substantially similar to inverter controller 800 (shown in FIG. 8), and components of FIG. 9 that are similar to components of FIG. 8 are illustrated with the same reference numerals in FIG. 9 as are used in FIG. 8.

In the embodiment illustrated in FIG. 9, a real component of the voltage of the grid, i.e., of electrical distribution network 106, is measured by one or more output voltage sensors (not shown), and a resulting real grid voltage signal 902 is generated. Real grid voltage signal 902 is inverted and is divided by 1.5 (i.e., multiplied by 2/3) to generate an inverted grid voltage signal 904.

Array voltage signal 820 is multiplied by array current signal 822, and array power signal 824 is generated as a result of the multiplication. Array power signal 824 is multiplied by inverted grid voltage signal 904 to generate inverter current command signal 808. Inverter current command signal 808 is compared to current command signal 802 and inverter current feedback signal 806 as described above. In other respects, inverter controller 900 operates substantially similar to inverter controller 800.

The embodiments described in FIGS. 8 and 9 facilitate reducing overvoltage conditions within DC bus 132 and/or power converter 104. More specifically, during startup or any other suitable operation of power converter 104, solar array 102 is electrically coupled to power converter 104 by protection device 110. As current begins to flow to power converter 104, DC bus voltage feedback signal 702 or real grid voltage signal 902 is used as a feedforward signal to at least partially generate inverter current command signal 808. Such a feedforward signal path facilitates increasing a speed of inverter current and/or voltage control and/or regulation as compared to inverter controllers that do not include the feedforward signal path. Accordingly, inverter controllers 800 and 900 facilitate reducing a time between the startup of power converter 104 and the time that a power output of power converter 104 is substantially equal to the power received from solar array 102, thus avoiding or reducing overvoltage conditions within DC bus 132 and/or power converter 104.

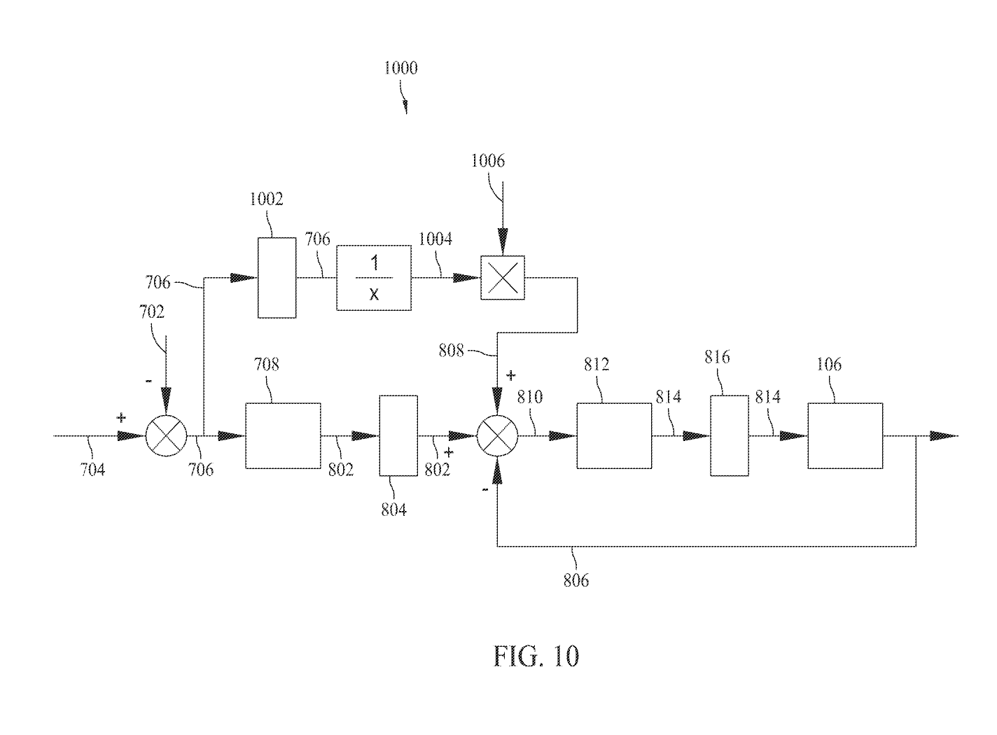

FIG. 10 is a schematic view of a portion of another exemplary inverter controller 1000 that may be used with power generation system 100 (shown in FIG. 1). Unless otherwise specified, inverter controller 1000 is substantially similar to inverter controller 800 (shown in FIG. 8), and components of FIG. 10 that are similar to components of FIG. 8 are illustrated with the same reference numerals in FIG. 10 as are used in FIG. 8. Moreover, in the exemplary embodiment, inverter controller 1000 facilitates maintaining the voltage across DC bus 132 at or below an operating threshold such that DC bus 132 does not experience an overvoltage condition.

In the embodiment illustrated in FIG. 10, a portion of DC bus voltage error signal 706 is transmitted to a third limiter 1002 that prevents DC bus voltage error signal 706 from being output unless an amplitude of signal 706 is between an upper limit and a lower limit of third limiter 1002. In the exemplary embodiment, the upper limit is approximately equal to 0 and the lower limit is approximately equal to a negative value of the operating threshold of the voltage across DC bus 132 minus DC bus voltage command signal 704 (i.e., approximately equal to DC bus voltage command signal 704 minus the operating threshold). Accordingly, DC bus voltage error signal 706 is transmitted from third limiter 1002 if DC bus voltage feedback signal 702 is greater than the operating threshold of the voltage across DC bus 132. The value of the operating threshold minus DC bus voltage command signal 704 is referred to as the “maximum voltage differential value.”

In the exemplary embodiment, DC bus voltage error signal 706 is divided by the absolute value of the maximum voltage differential value such that an adjusted DC bus voltage error signal 1004 is generated. Inverter controller 1000 and/or any other controller or system determines a maximum amount of current (hereinafter referred to as a “maximum line current”) that may be transmitted from inverter 130 to electrical distribution network 106. A maximum line current signal 1006 representative of the maximum line current is multiplied by adjusted DC bus voltage error signal 1004 to generate inverter current command signal 808. In other respects, inverter controller 1000 operates substantially similar to inverter controller 800.

During startup or any other suitable operation of power converter 104, inverter controller 1000 disables the switching of inverter switches 150 and/or maintains inverter switches 150 in an open state such that current is substantially prevented from flowing through inverter 130. Solar array 102 is electrically coupled to power converter 104 by protection device 110 and current begins to flow to power converter 104. Inverter controller 1000 enables the switching of inverter switches 150 and the voltage across DC bus 132 increases. If the voltage across DC bus 132 (i.e., DC bus voltage feedback signal 702) increases above the operating voltage, inverter current command signal 808 increases such that an increasing amount of current is generated from inverter 130. Accordingly, inverter controller 1000 facilitates counteracting the increasing voltage across DC bus 132 by increasing the current supplied by inverter 130, thus avoiding or reducing overvoltage conditions within DC bus 132 and/or power converter 104.

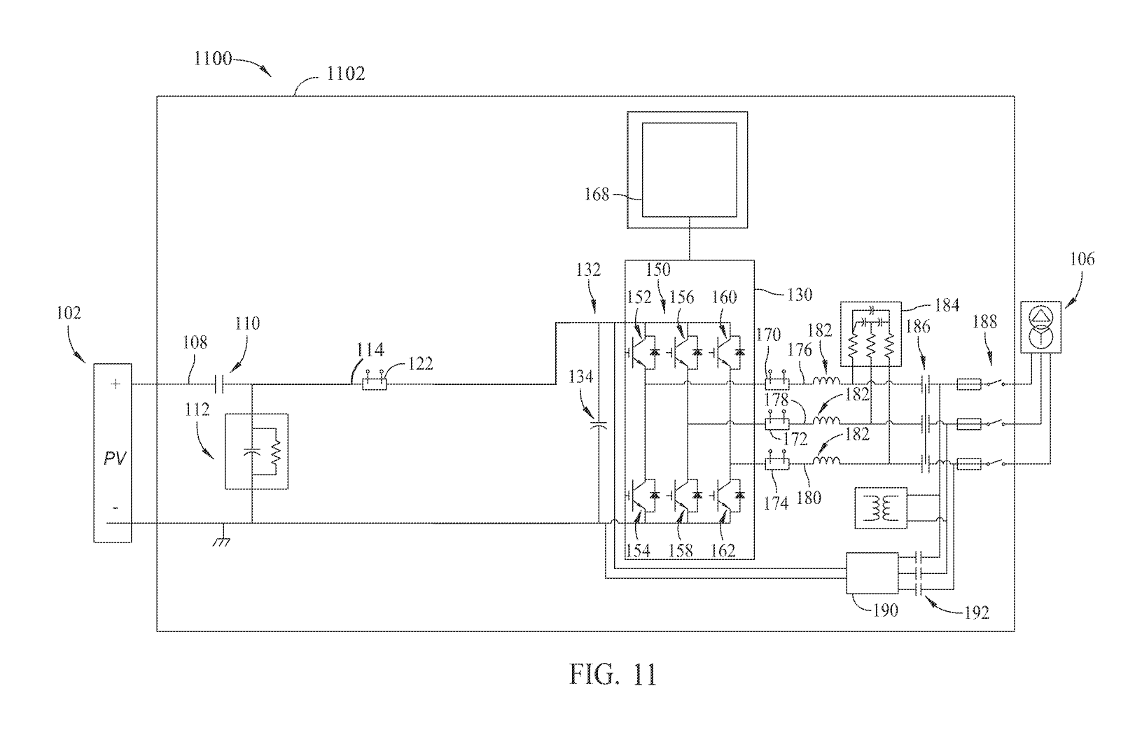

FIG. 11 is a schematic diagram of an alternative power generation system 1100. Unless otherwise specified, power generation system 1100 is substantially similar to power generation system 100 (shown in FIG. 1), and components of FIG. 11 that are similar to components of FIG. 1 are illustrated with the same reference numerals in FIG. 11 as are used in FIG. 1.

Power generation system 1100 includes a power converter 1102 coupled to solar array 102. In contrast to power converter 104 (shown in FIG. 1), power converter 1102 does not include a boost converter 128 (shown in FIG. 1). Accordingly, power converter 104 is known as a “dual stage” power converter 104, and power converter 1102 is known as a “single stage” power converter 1102.

In the alternative embodiment, power converter 1102 does not include inductors 120, second input conductor 116, and third input conductor 118 (all shown in FIG. 1). Solar array 102 is coupled to DC bus 132 and to inverter 130 by conductor 108, protection device 110, and first input conductor 114. First input current sensor 122 measures the current flowing through first input conductor 114 as described above with reference to FIG. 1. In other respects, power converter 1102 operates similarly to power converter 104 with suitable modifications known to one of ordinary skill in the art. In addition, power generation system 1100 and/or power converter 1102 may be used with any of the embodiments described herein with suitable modifications made by one of ordinary skill in the art.

A technical effect of the systems and methods described herein includes at least one of: (a) enabling a switching operation of a power converter system; (b) electrically coupling a power generation unit to a power converter system; and (c) supplying power from a power generation unit to an electrical distribution network coupled to a power converter system.

The above-described embodiments facilitate providing an efficient and cost-effective power converter for use with at least one power generation unit, such as a solar array. The power converter includes a boost converter coupled to the solar array, and an inverter coupled to the boost converter by a DC bus. The inverter is coupled to an electrical distribution network for supplying electrical energy to the network. A converter controller controls the operation of the boost converter, and an inverter controller controls the operation of the inverter. The converter controller and the inverter controller adjust the operation of the boost converter and the inverter, respectively, to adjust the voltage across the DC bus if the electrical distribution network has a different voltage than the voltage supplied by the solar array and/or if an error or fault condition occurs within the electrical distribution network. Accordingly, the power converter and the methods described herein enable a power generation system to operate during low voltage events and/or high voltage events without sustaining undesired voltage amplitudes across the DC bus.

Exemplary embodiments of a power generation system, a power converter system, and methods for operating a power converter system are described above in detail. The power generation system, power converter system, and methods are not limited to the specific embodiments described herein, but rather, components of the power generation system and/or power converter system and/or steps of the methods may be utilized independently and separately from other components and/or steps described herein. For example, the power converter system may also be used in combination with other power generation systems and methods, and is not limited to practice with only the solar power system as described herein. Rather, the exemplary embodiment can be implemented and utilized in connection with many other renewable energy and/or power generation applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

| | |
|---|---|
| 100 | Power generation system |
| 102 | Solar array |
| 104 | Power converter |
| 106 | Distribution network |
| 108 | Converter conductor |
| 110 | Protection device |
| 112 | DC filter |
| 114 | First input conductor |
| 116 | Second input conductor |
| 118 | Third input conductor |
| 120 | Inductor |
| 122 | First input current sensor |
| 124 | Second input current sensor |
| 126 | Third input current sensor |
| 128 | Boost converter |
| 130 | Inverter |
| 132 | DC bus |
| 134 | Capacitor |
| 136 | Converter switch |
| 138 | First converter switch |
| 140 | Second converter switch |
| 142 | Third converter switch |
| 144 | Fourth converter switch |
| 146 | Fifth converter switch |
| 148 | Sixth converter switch |
| 150 | Inverter switch |
| 152 | First inverter switch |
| 154 | Second inverter switch |
| 156 | Third inverter switch |
| 158 | Fourth inverter switch |
| 160 | Fifth inverter switch |
| 162 | Sixth inverter switch |
| 164 | Control system |
| 166 | Converter controller |
| 168 | Inverter controller |
| 170 | First output current sensor |
| 172 | Second output current sensor |
| 174 | Third output current sensor |
| 176 | First output conductor |
| 178 | Second output conductor |
| 180 | Third output conductor |
| 182 | Inductor |
| 184 | AC filter |
| 186 | Contactor |
| 188 | Disconnect switch |
| 190 | Bus charger |
| 192 | Charger contactor |
| 200 | Startup sequence |
| 202 | Close disconnect switches |
| 204 | Precharge DC bus using AC power from power distribution |
| | network |
| 206 | Enable inverter switching operation |
| 208 | Close protection device |
| 210 | Enable boost converter switching operation |
| 212 | Supply power from solar array to power distribution network |
| 300 | Method of operating power converter |
| 302 | Detect low voltage event |
| 304 | Disable inverter switching operation |
| 306 | Wait for predetermined time to elapse |
| 308 | Operate inverter to supply reactive power to power distribution |
| | network |
| 310 | Operate boost converter in reduced power mode |
| 312 | Reduce DC bus voltage |
| 314 | Wait until low voltage event is corrected or removed |
| 316 | Resume normal operation |
| 400 | Shutdown sequence |
| 402 | Disable switching operation of boost converter |
| 404 | Open protection device |
| 406 | Disable switching operation of inverter |
| 408 | Discharge DC bus |
| 410 | Maintain converter in shutdown state |
| 500 | Converter controller |
| 502 | Array voltage reference signal |
| 504 | Measured array voltage signal |
| 506 | Array voltage error signal |
| 508 | Array DC voltage regulator |
| 510 | Array voltage control signal |
| 512 | Contactor |
| 514 | Array current limit |
| 516 | Array current signal |
| 518 | Current error signal |
| 520 | Current regulator |
| 522 | Current control signal |
| 524 | Array power limit |
| 526 | Measured array power signal |
| 528 | Over power error signal |
| 530 | Over power regulator |
| 532 | Current control signal |
| 534 | Voltage change limit |
| 536 | Measured voltage change signal |
| 538 | Voltage change error signal |
| 540 | Voltage change regulator |
| 542 | Voltage change control signal |
| 600 | Power output curve |
| 602 | Power output |
| 604 | Voltage output |
| 606 | Maximum power level |
| 608 | First operating region |
| 610 | Second operating region |
| 700 | Inverter controller |
| 702 | Bus voltage feedback signal |
| 704 | Bus voltage command signal |
| 706 | Bus voltage error signal |
| 708 | DC bus voltage regulator |
| 710 | Current limit reference signal |
| 712 | Real current feedback signal |
| 714 | Real current error signal |
| 716 | Real current regulator |
| 718 | Real voltage command signal |
| 720 | Output reference frame converter |
| 722 | Input reference frame converter |
| 800 | Inverter controller |
| 802 | Current command signal |
| 804 | First limiter |
| 806 | Inverter current feedback signal |
| 808 | Inverter current command signal |
| 810 | Current error signal |
| 812 | Current regulator |
| 814 | Voltage command signal |
| 816 | Second limiter |
| 818 | DC bus voltage signal |
| 820 | Array voltage signal |
| 822 | Array current signal |
| 824 | Array power signal |
| 900 | Inverter controller |
| 902 | Real grid voltage signal |
| 904 | Inverted grid voltage signal |
| 1000 | Inverter controller |
| 1002 | Third limiter |
| 1004 | Voltage error signal |
| 1006 | Maximum line current signal |
| 1100 | Power generation system |
| 1102 | Power converter |

What is claimed is:

1. A power converter system comprising:
a converter configured to be coupled to a power generation unit for receiving power from the power generation unit;
a bus coupled to the converter, wherein a voltage is generated across the bus when electricity is conducted through the power converter system;
an inverter coupled to the bus and configured to supply power to an electrical distribution network; and,
a control system coupled to at least one of the converter and the inverter, the control system configured to adjust an operation of the at least one of the converter and the inverter to reduce the voltage across the bus during at least one of a low voltage event and a high voltage event.

2. The power converter system in accordance with claim 1, wherein the control system is configured to operate the converter to reduce the power received from the power generation unit during the at least one of a low voltage event and a high voltage event.

3. The power converter system in accordance with claim 1, wherein the inverter comprises at least one switch, the control system is configured to disable the at least one switch during the at least one of a low voltage event and a high voltage event.

4. The power converter system in accordance with claim 1, wherein the control system is configured to enable a current to be transmitted from the bus to the power generation unit during the at least one of a low voltage event and a high voltage event.

5. The power converter system in accordance with claim 1, wherein the converter comprises at least one switch, the control system is configured to control the switching of the at least one switch to limit a voltage change across the bus during the at least one of a low voltage event and a high voltage event.

6. The power converter system in accordance with claim 1, wherein the control system comprises an inverter controller configured to use a feedforward voltage signal to reduce a difference between the power received from the power generation unit and the power supplied to the electrical distribution network.

7. The power converter system in accordance with claim 1, wherein the control system comprises a converter controller coupled to the converter, the converter controller configured to control an operation of the converter to limit an amount of change in the voltage across the bus.

8. A power generation system, comprising:
a power generation unit configured to generate power; and,
a power converter system coupled to the power generation unit and to an electrical distribution network, the power converter system comprising:
a converter configured to receive power from the power generation unit;
a bus coupled to the converter, wherein a voltage is generated across the bus when electricity is conducted through the power converter system;
an inverter coupled to the bus and configured to supply power to the electrical distribution network; and,
a control system coupled to at least one of the converter and the inverter, the control system configured to adjust an operation of the at least one of the converter and the inverter to reduce the voltage across the bus during at least one of a low voltage event and a high voltage event.

9. The power generation system in accordance with claim 8, wherein the control system is configured to operate the converter to reduce the power received from the power generation unit during the at least one of a low voltage event and a high voltage event.

10. The power generation system in accordance with claim 8, wherein the inverter comprises at least one switch, the control system is configured to disable the at least one switch during the at least one of a low voltage event and a high voltage event.

11. The power generation system in accordance with claim 8, wherein the control system is configured to enable a current to be transmitted from the bus to the power generation unit during the at least one of a low voltage event and a high voltage event.

12. The power generation system in accordance with claim 8, wherein the converter comprises at least one switch, the control system is configured to control the switching of the at least one switch to limit a voltage change across the bus during the at least one of a low voltage event and a high voltage event.

13. The power generation system in accordance with claim 8, wherein the control system comprises an inverter controller configured to use a feedforward voltage signal to reduce a difference between the power received from the power generation unit and the power supplied to the electrical distribution network.

14. The power generation system in accordance with claim 8, wherein the control system comprises a converter controller coupled to the converter, the converter controller configured to control an operation of the converter to limit an amount of change in the voltage across the bus.

15. A method of operating a power converter system, the method comprising:
enabling a switching operation of the power converter system;
electrically coupling a power generation unit to the power converter system; and,
supplying power from the power generation unit to an electrical distribution network coupled to the power converter system.

16. The method in accordance with claim 15, further comprising adjusting an operation of the power converter system to reduce a voltage within the power converter system during at least one of a low voltage event and a high voltage event.

17. The method in accordance with claim 15, further comprising adjusting an operation of the power converter system to reduce a change in voltage within the power converter system during at least one of a low voltage event and a high voltage event.

18. The method in accordance with claim 15, further comprising precharging the bus using power received from the electrical distribution network before the enabling a switching operation of the power converter system.

19. The method in accordance with claim 15, further comprising:
electrically decoupling the power generation unit from the power converter system; and,
disabling the switching operation of the power converter system.

20. The method in accordance with claim 15, wherein the power converter system includes at least one of a converter and an inverter, the enabling a switching operation of the power converter system comprising enabling a switching operation of the at least one of the converter and the inverter.
